(19) United States
(12) Patent Application Publication
(10) Pub. No.: US 2015/0280524 A1
(43) Pub. Date: Oct. 1, 2015

(54) METHOD AND DEVICE FOR LIQUID COOLING OF AN ELECTRIC MOTOR

(71) Applicant: BAE SYSTEMS HÄGGLUNDS AKTIEBOLAG, Örnsköldsvik (SE)

(72) Inventor: Viktor Lassila, Arnasvall (SE)

(73) Assignee: BAE Systems Hägglunds Aktiebolag, Örnsköldsvik (SE)

(21) Appl. No.: 14/441,368

(22) PCT Filed: Oct. 24, 2013
(86) PCT No.: PCT/SE2013/051244

§ 371 Date: May 7, 2015

(30) Foreign Application Priority Data
Nov. 7, 2012 (SE) 1251265-3

(51) Int. Cl. H02K 9/19

(52) U.S. Cl. CPC H02K 9/19

(57) ABSTRACT

The present invention relates to a method for liquid cooling of an electric motor (1) of inner rotor type comprising a rotor (10) and a stator (30) provided with windings, comprising the steps of: supplying (S1) a liquid (O) for said liquid cooling to a cooling flange configuration (40) of at least one end (10a, 10b) of said rotor (10); and by means of the rotation of the rotor supplying (S2) liquid also to said stator (30) by means of said cooling flange configuration (40). The present invention also relates to a device for liquid cooling of an electric motor (1) of inner rotor type. The present invention also relates to a motor vehicle.

### TECHNICAL FIELD

The invention relates to a method for liquid cooling of an electric motor according to the preamble of claim 1. The invention relates to a device for liquid cooling of an electric motor according to the preamble of claim 5. The invention also relates to a motor vehicle.

### BACKGROUND ART

During drive electric motors are heated whereby cooling is required to divert the heat. Cooling of an electric motor may be effected by means of different types of cooling media such as e.g. air, water or oil.

In e.g. high performance electric motors efficient cooling is highly essential in order to achieve good performance. Liquid cooling by means of e.g. oil may hereby result in efficient cooling of the electric motor and consequently improve performance of the electric motor.

### OBJECTS OF THE INVENTION

An object of the present invention is to provide a method for liquid cooling of an electric motor which results in easy and efficient cooling of the electric motor.

An object of the present invention is to provide a device for liquid cooling of an electric motor which results in easy and efficient cooling of the electric motor.

### SUMMARY OF THE INVENTION

These and other objects, apparent from the following description, are achieved by a method and a device and a motor vehicle which are of the type stated by way of introduction and which in addition exhibits the features recited in the characterising clause of the appended claims 1, 5 and 9.

Preferred embodiments of the method and the device are defined in appended dependent claims 2-4 and 6-8.

Specifically an object of the invention is achieved by with a method for liquid cooling of an electric motor of inner rotor type comprising a rotor and a stator provided with windings, comprising the steps of: supplying a liquid for said liquid cooling to a cooling flange configuration of at least one end of said rotor and by means of the rotation of the rotor supplying liquid also to said stator by means of said cooling flange configuration. Hereby the liquid for cooling comes into direct contact or in the vicinity of parts of the rotor creating losses at the same time as the liquid is thrown towards the stator, particularly the stator windings and their coil ends, wherein consequently efficient cooling is obtained in that a good thermal contact between stator winding and the cooling liquid is guaranteed thanks to direct cooling. Further, no precision spraying is required as the distribution of the cooling liquid is effected by means of rotation of the rotor and via the rotor.

According to an embodiment of the method said liquid is oil-based. Hereby efficient cooling if facilitated in that oil is a very efficient cooling liquid. Further, use of oil in an oil sump of a vehicle is facilitated, where e.g. an electric motor integrated in a gear box may use the oil of the gear box for cooling of the electric motor by supplying the oil to the cooling flange configuration.

According to an embodiment of the method said cooing flange configuration comprises wing elements. Hereby efficient distribution/throwing of the supplied liquid is obtained by means of said wing elements.

According to an embodiment of the method said wing elements run essentially from a central portion to a peripheral portion of said rotor end in order to, during rotation, throw said liquid towards an end portion of the stator comprising the end coils of the stator windings. Hereby efficient cooling of the stator is facilitated, the end coils of the stator windings constituting the hottest portions and consequently having the greatest need for cooling. Such shaped wing elements facilitates efficient distribution/throwing of the supplied liquid during rotation.

According to the invention the objects are achieved with a device for liquid cooling of an electric motor of inner rotor type comprising a rotor and a stator provided with windings, comprising means for supplying a liquid for said cooling to a cooling flange configuration of at least one end of said rotor in order to, by means of rotation of the rotor, supply liquid also to said stator by means of said cooling flange configuration. Hereby the liquid for cooling comes into direct contact or in the vicinity of parts of the rotor creating losses at the same time as the liquid is thrown towards the stator, particularly the stator windings and their coil ends, wherein consequently efficient cooling is obtained in that a good thermal contact between stator winding and the cooling liquid is guaranteed thanks to direct cooling. Further, no precision spraying is required as the distribution of the cooling liquid is effected by means of rotation of the rotor and via the rotor.

According to an embodiment of the device said liquid is oil-based. Hereby efficient cooling if facilitated in that oil is a very efficient cooling liquid. Further, use of oil in an oil sump of a vehicle is facilitated, where e.g. an electric motor integrated in a gear box may use the oil of the gear box for cooling of the electric motor by supplying the oil to the cooling flange configuration.

According to an embodiment of the device said cooing flange configuration comprises wing elements. Hereby efficient distribution/throwing of the supplied liquid is obtained by means of said wing elements.

According to an embodiment of the device said wing elements run essentially from a central portion to a peripheral portion of said rotor end in order to, during rotation, throw said liquid towards an end portion of the stator comprising the end coils of the stator windings. Hereby efficient cooling of the stator is facilitated, the end coils of the stator windings constituting the hottest portions and consequently having the greatest need for cooling. Such shaped wing elements facilitates efficient distribution/throwing of the supplied liquid during rotation.

### BRIEF DESCRIPTION OF THE DRAWINGS

A better understanding of the present invention will be had upon the reference to the following detailed description when read in conjunction with the accompanying drawings, wherein like reference characters refer to like parts throughout the several views, and in which:

FIG. 1 schematically illustrates a motor vehicle according t an embodiment of the present invention;

FIG. 2 schematically illustrates a perspective view of a part of an electric motor with a device for liquid cooling of the electric motor according to an embodiment of the present invention;

FIG. 3 schematically illustrates a side view of the electric motor with device shown in FIG. 2;

FIG. 4 schematically illustrates a side view of an axial cross section of the electric motor with device shown in FIG. 2; and

FIG. 5 schematically illustrates a block diagram of a method for liquid cooling of an electric motor according to an embodiment of the present invention.

### DETAILED DESCRIPTION

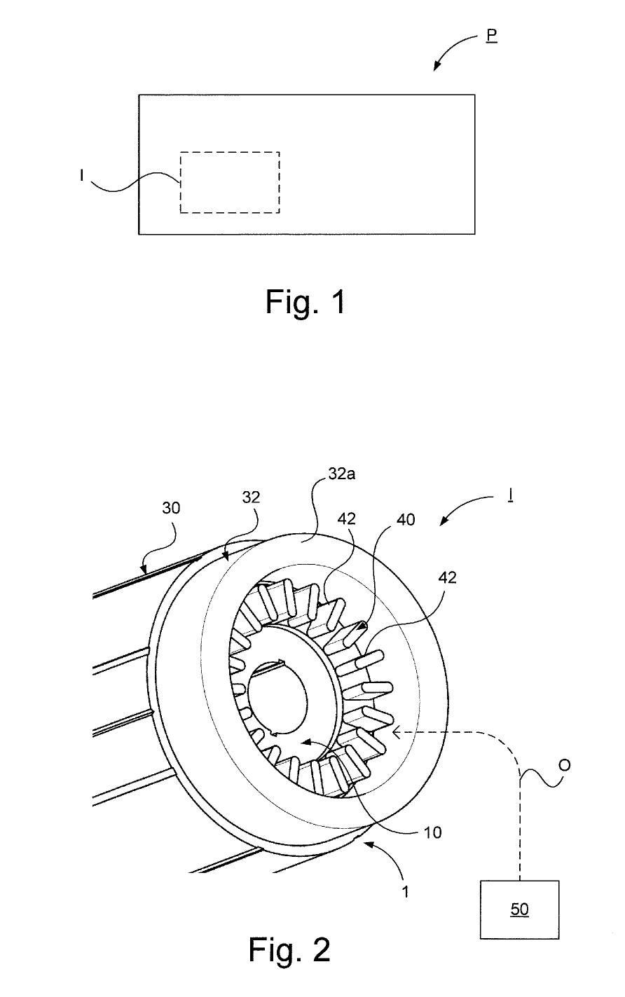

With reference to FIG. 1 a platform P is shown, the platform P being comprised in a group comprising motor vehicles such as military vehicles, work vehicles, private car, boat, helicopter or the corresponding, a power station, any electrically driven machine or the corresponding, the device comprising an electric motor for driving of the same. The platform P comprises at least one electric motor 1 comprising a device I for liquid cooling of the electric motor 1 according to the present invention.

FIG. 2 schematically illustrates a perspective view of a part of an electric motor 1 with a device I for liquid cooling of the electric motor according to an embodiment of the present invention, fig. A side view of the electric motor 1 with device I shown in FIG. 2, and FIG. 4 an axial cross section of the electric motor 1 with device I shown in FIG. 2.

The electric motor 1 is of inner rotor type comprising a rotor 10 and a stator 30 provided with windings. With electric motor 1 of inner rotor type is intended an electric motor 1 where the stator 30 is arranged to surround the rotor 10. The external surface of the rotor 10 is arranged adjacent to and separated from the internal surface of the stator 30. The rotor 10 is according is according to a variant built up by stacked rotor plates, not shown. The rotor 10 is arranged concentrically relative to the stator 30.

Said rotor 10 is intended to be connected to a not shown drive shaft and is thus arranged to rotate the drive shaft. The rotor 10 has opposite rotor ends 10a, 10b.

The stator 30 is according to a variant built up by stacked stator plates (not shown). The stator 30 comprises a stator winding 32. The stator winding comprises according to a variant a set of electrically conductive wires/conductors, through which a current is arranged to be conducted for driving of the electric motor 1. Said conductors may be of different thickness. Said stator winding 32 is arranged to run axially such that the winding adjoins adjacently to the rotor. The stator winding 32 is arranged to axially project form end portions 30a, 30b of the stator 30, turn outside the end portions 30a, 30b and be re-introduced through the end portions, wherein said projecting portion 32a of the stator winding 32 forms a so called coil end 32b.

The stator winding 32 of the stator 30 is according to the present invention arranged to run along and axially projecting from and turn outside of the jacket surface of the stator 30.

The device comprises a cooling flange configuration 40 arranged at the respective rotor end. The rotor consequently comprises a cooling flange configuration 40 arranged at the respective rotor end 10a, 10b.

According to this embodiment said cooling flange configuration 40 comprises wing elements 42. Said wing elements 42 are arranged to run essentially from a central portion 12 to a peripheral portion 14 of said rotor end 10a, 10b. According to this embodiment said wing elements 42 are arranged to run essentially radially from said central portion 12 to said peripheral portion 14 of the respective rotor end 10a, 10b.

The respective rotor end 10a, 10b is arranged to receive a liquid cooling medium O, i.e. a liquid for cooling of the electric motor. The liquid cooling medium O is according to a variant constituted by oil. The liquid cooling medium O is arranged to be supplied to the respective end 10a, 10b of said rotor 10 for cooling of said stator 30. By supplying of said cooling liquid O to said rotor 10 the rotor 10 is hereby also cooled.

The device I for liquid cooling of the electric motor 1 comprises means 50 for supplying the liquid medium/the liquid=for said cooing to at least one end 10a, 10b of said rotor 10, the rotor being provided with the cooling flange configuration 40 comprising said wing elements 42. Said cooling flange configuration 40 comprising said wing elements 42 is arranged through the rotation of the rotor 10 to supply liquid also to said stator 30 by means of said cooling flange configuration 40 by throwing the thus supplied cooling liquid O by means of said wing elements during rotation of the rotor 10. According to this embodiment of the invention said wing elements 42 are arranged during rotation of the rotor 10 to throw said liquid O towards an end portion of the stator 30 comprising the coil ends 32a of the stator winding 32.

Said wing elements 42 are consequently arranged such that they during rotation of the rotor throw liquid supplied to the rotor end 10a, 10b in direction towards the coil ends 32a of the stator winding 32. Said wing elements 42 are consequently arranged to receive cooling liquid O supplied to the rotor end 10a, 10b and by rotation of the rotor 10 throw said received cooling liquid O in direction towards that stator 30 and the coil ends 32a of the stator winding 32.

The means 50 for supplying of cooling liquid O comprises according to a variant at least one pump arranged to pump cooling liquid O from a sump in a not shown housing for the electric motor 1. Where the liquid O is constituted by oil the sump consequently is constituted by an oil sump. An electric motor integrated in a gearbox uses the gearbox oil for cooling of the electric motor 1 by supplying the oil to the cooling flange configuration 40.

According to a variant the pump is connected to the electric motor 1 in such a way that the pump is activated during drive of the electric motor 1 such that cooling liquid O may be supplied to the respective end 10a, 10b of the rotor 10, i.e. by supplied to the cooling flange configuration 40 comprising wing elements 42, when there is a need, i.e. when the electric motor 1 is driven such that the rotor 10 rotates.

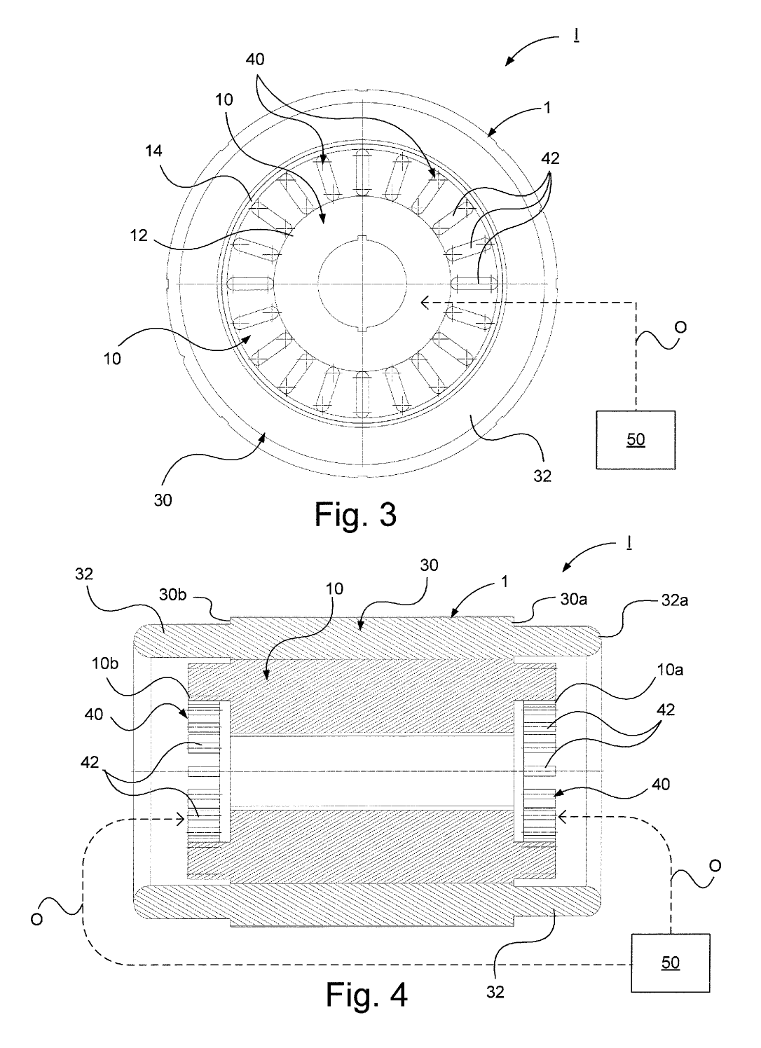

According to the device according to the embodiment illustrated in FIG. 2-4 said cooling flange configuration 40 for during rotation of the rotor 10 throwing cooling liquid received by the respective rotor end 10a, 10b towards the stator winding 32 and its coli ends 32a comprises wing elements 42 radially running from a central portion 12 to a peripheral portion 14 of the rotor end 10a, 10b. Said cooling flange configuration 40 may have any suitable shape for providing throwing of received liquid during rotation of the rotor 10. The cooling flange configuration may comprise wing elements running from a central to a peripheral portion of the rotor end with a certain angle relative to the radial extension. The cooling flange configuration may comprise wing elements running from a central to a peripheral portion of the rotor end with a certain curve of said wing element.

The shape of said cooling flange configuration 40 is according to a variant adapted for optimizing cooling to specific needs of the specific electric motor 1. Hereby is according to an embodiment wing elements of the cooling flange configuration shaped such that received cooling liquid is thrown in direction towards areas where cooling need of the electric motor and its stator is present.

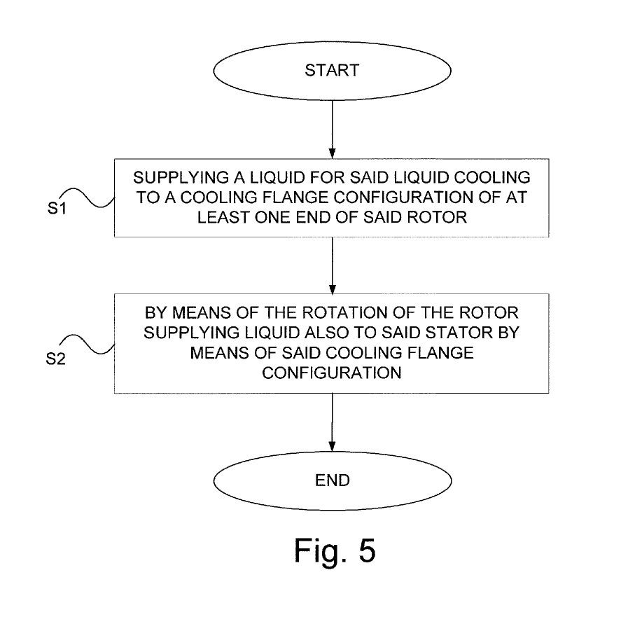

FIG. 5 schematically illustrates a block diagram of a method for liquid cooling of an electric motor of inner rotor type comprising a rotor and a stator provided with windings according to an embodiment of the present invention.

According to an embodiment the method for liquid cooling of such en electric motor comprises a first step S1. In this a liquid for said cooling is supplied to cooling flange configuration of at least one end of said rotor.

According to an embodiment the method for liquid cooling of such an electric motor comprises a second step S2. In this step by means of the rotation of the rotor liquid is supplied also to said stator by means of said cooling flange configuration.

The foregoing description of the preferred embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated.

1. A method for liquid cooling of an electric motor of inner rotor type comprising a rotor and a stator provided with windings, comprising the steps of:
supplying a liquid for said liquid cooling to a cooling flange configuration of at least one end of said rotor; and
by means of the rotation of the rotor supplying liquid also to said stator by means of said cooling flange configuration.

2. A method according to claim 1, wherein said liquid is oil-based.

3. A method according to claim 1, wherein said cooing flange configuration comprises wing elements.

4. A method according to claim 1, wherein said wing elements run essentially from a central portion to a peripheral portion of said rotor end in order to, during rotation, throw said liquid towards an end portion of the stator comprising the end coils of the stator windings.

5. A device for liquid cooling of an electric motor of inner rotor type comprising a rotor and a stator provided with windings, the device comprising:
a member for supplying a liquid for said cooling to a cooling flange configuration of at least one end of said rotor in order to, by means of rotation of the rotor, supply liquid also to said stator by means of said cooling flange configuration.

6. A device according to claim 5, wherein said liquid is oil-based.

7. A device according to claim 5, wherein said cooing flange configuration comprises wing elements.

8. A device according to claim 5, wherein said wing elements run essentially from a central portion to a peripheral portion of said rotor end in order to, during rotation, throw said liquid towards an end portion of the stator comprising the end coils of the stator windings.

9. Motor vehicle comprising a device according to claim 5.
